(19) United States
(12) Patent Application Publication
(10) Pub. No.: US 2018/0070590 A1
(43) Pub. Date: Mar. 15, 2018

(54) Enhanced Biocide Composition Containing An Isothiazolinone and a Pyrithione

(71) Applicant: Lonza Inc., Allendale, NJ (US)

(72) Inventors: Scott Brown, Gainesville, GA (US); Kathryn Neely, Cumming, GA (US); Michelle Rioux, Cumming, GA (US)

(21) Appl. No.: 15/698,846

(22) Filed: Sep. 8, 2017

Related U.S. Application Data
(60) Provisional application No. 62/385,582, filed on Sep. 9, 2016.

(51) Int. Cl. A01N 43/40; A01N 43/80; A01N 59/16; A01N 33/08; C09D 5/14

(52) U.S. Cl. CPC A01N 43/40; A01N 43/80; C09D 5/14; A01N 33/08; A01N 59/16

(57) ABSTRACT

The present disclosure is directed to an enhanced biocide composition containing an isothiazolinone and a pyrithione. In particular, the composition contains an isothiazolinone, a pyrithione, a zinc compound, and an organic amine. According to the present disclosure, the combination of components employed within the composition provides a synergistic effect against microorganisms, such as bacteria and fungi.

### RELATED APPLICATIONS

The present application is based on and claims priority to U.S. Provisional Patent application Ser. No. 62/385,582, filed on Sep. 9, 2016, which is incorporated herein by reference.

### BACKGROUND

Many compositions and formulations are known in the art for the prevention, inhibition, and treatment of growth or infestation of microbes. In particular, the active ingredients and components of these compositions and formulations are selected based on the need for a certain biocidal activity.

As generally known in the art, these biocides can include isothiazolinones and pyrithiones. However, while higher concentrations of these biocides have been observed to inhibit or control the growth of microorganisms, the amount employed in practice for a certain biocidal activity or efficacy can be limited. For instance, due to economic, environmental, and/or toxicological considerations, it is desirable to improve the biocidal efficacy at a specific use level and/or reduce the amount of the biocide required for a desired efficacy in an industrial application.

Accordingly, there is a need for a composition which offers an enhanced biocidal efficacy against microorganisms. Such a composition would be highly efficacious, cost-effective, and/or possess an enhanced biocidal effect.

### SUMMARY

In general, one embodiment of the present disclosure is directed to a biocide composition. The biocide composition comprises an isothiazolinone, a pyrithione, a zinc compound, and an organic amine compound.

In one embodiment, the isothiazolinone comprises 1,2-benzisothiazolin-3-one, N-butyl-1,2-benzisothiazolin-3-one, N-methyl-1,2-benzisothiazolin-3-one, 2-methyl-2H-isothiazol-3-one, 5-chloro-2-methyl-2H-isothiazol-3-one, 2-octyl-3(2H)-isothiazolone, 4,5-dichloro-2n-octyl-3(2H)-isothiazolone, 2,2-dithiobis(N-methylbenzamide), or any combination thereof. In a further embodiment, the isothiazolinone comprises 1,2-benzisothiazolin-3-one, N-butyl-1,2-benzisothiazolin-3-one, or any combination thereof. In one particular embodiment, the isothiazolinone comprises 1,2-benzisothiazolin-3-one.

In one embodiment, the pyrithione comprises sodium pyrithione, bismuth pyrithione, potassium pyrithione, lithium pyrithione, ammonium pyrithione, zinc pyrithione, copper pyrithione, calcium pyrithione, magnesium pyrithione, strontium pyrithione, silver pyrithione, gold pyrithione, manganese pyrithione, an organic amine pyrithione, or any combination thereof. In one particular embodiment, the pyrithione comprises sodium pyrithione. In a further embodiment, the pyrithione comprises an alkali metal salt of pyrithione.

In one embodiment, the zinc compound comprises a zinc salt of an organic acid, a zinc salt of an inorganic acid, a zinc oxide, a zinc hydroxide, or any combination thereof. In one particular embodiment, the zinc compound comprises a zinc salt of an inorganic acid. In another particular embodiment, the zinc compound comprises zinc chloride.

In one embodiment, the zinc compound comprises a zinc salt selected from the group consisting of zinc acetate, zinc borate, zinc bromide, zinc carbonate, basic zinc carbonate, zinc chloride, zinc sulfate, zinc citrate, zinc fluoride, zinc iodide, zinc lactate, zinc oleate, zinc oxalate, zinc phosphate, zinc propionate, zinc salicylate, zinc selenate, zinc silicate, zinc stearate, zinc sulfide, zinc sulfate, zinc tannate, zinc tartrate, zinc valerate, or any combination thereof. In another embodiment, the zinc compound comprises a binary zinc compound selected from the group consisting of zinc oxide, zinc sulfide, zinc fluoride, zinc iodide, zinc chloride, zinc bromide, zinc peroxide, zinc hydride, zinc carbide, zinc nitride, or any combination thereof.

In one embodiment, the organic amine comprises a compound of the following formula

NR¹R²R³

wherein

R¹, R², and R³ are individually hydrogen or a C₁₋₅ alkyl, optionally substituted, wherein at least one of R¹, R², and R³ is a C₁₋₅ alkyl, optionally substituted. In one embodiment, at least two of R¹, R², and R³ are hydrogen and at least one of R¹, R², and R³ is a C₁₋₅ alkyl, In one embodiment, the C₁-₅ alkyl is substituted with a hydroxyl group. In one particular embodiment, the organic amine comprises an alkanolamine. In a further particular embodiment, the organic amine comprises ethanolamine.

In one particular embodiment, the composition further comprises a second organic amine. In one embodiment, the second organic amine is selected from the group consisting of a monomer or a polymer of an alkyl diamine of the following formula

R⁷R⁸N—[(CH₂)ₚ—CH₂—NH—]_{q}—H

wherein

R⁷ and R⁸ are individually hydrogen or a C₁₋₅ alkyl, optionally substituted,

p is 1 or 2, and

q is from about 1 to about 2000.

In one embodiment, the weight ratio of the pyrithione to the isothiazolinone is from 0.1 to 10. In on embodiment, the weight ratio of the isothiazolinone to the zinc compound is from 0.005 to 200.

In general, in another embodiment, the present disclosure is directed to an end-use formulation containing the biocide composition. The biocide composition comprises an isothiazolinone, a pyrithione, a zinc compound, and an organic amine compound.

In general, in another embodiment, the present disclosure is directed to a coating composition. The coating composition comprises a biocide composition. The biocide composition comprises an isothiazolinone, a pyrithione, a zinc compound, and an organic amine compound.

In general, in another embodiment, the present disclosure is directed to a method of preserving a substrate. The method comprises a step of applying a coating composition to the substrate. The biocide composition comprises an isothiazolinone, a pyrithione, a zinc compound, and an organic amine compound.

In general, in another embodiment, the present disclosure is directed to an antimicrobial composition concentrate. The concentrate comprises an isothiazolinone, a pyrithione, a zinc compound, and an organic amine compound.

Other features and aspects of the present disclosure are discussed in greater detail below.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations.

Generally speaking, the present disclosure is directed to a biocide composition. In accordance with the present disclosure, the biocide composition comprises an isothiazolinone, a pyrithione, a zinc compound, and an organic amine. The present inventors have discovered that the combination of the aforementioned components provides a synergistic effect, in particular against bacteria and fungi.

This enhanced efficacy allows for obtaining a desired antimicrobial and/or biocidal activity. In particular, such desired activity can be achieved at a lower concentration of active ingredients. For instance, in accordance with the teachings herein, the amount of the isothiazolinone and the pyrithione required to achieve a desired activity is less than when employing each of the active ingredients alone. Such enhancements allow for an efficient use of the composition, and the components employed therein, while also being cost-effective.

In particular, the sum of the fractional inhibitory concentrations of the isothiazolinone and the pyrithione may be less than 1 when tested against a target microorganism. The fractional inhibitory concentration is calculated as the concentration of a biocide which controlled growth in a mixture divided by the amount of biocide required to control growth when used alone. The fractional inhibitory concentration of a biocide can be calculated by dividing the concentration of the biocide attributable to antimicrobial activity in a mixture of the first biocide and the second biocide divided by the minimum inhibitory concentration of the biocide when tested against the target microorganism. The minimum inhibitory concentration is the lowest concentration of biocide which showed growth inhibition when used alone. In accordance with the present disclosure, when targeting a particular microorganism, the sum of the fractional inhibitory concentrations of the first biocide and the second biocide can be less than about 0.9, such as less than about 0.8, such as less than about 0.7. Any value less than 1 indicates synergistic interactions.

As indicated above, such fractional inhibitory concentrations can be realized when comparing the isothiazolinone and the pyrithione. However, it should be understood that such fractional inhibitory concentrations may also be realized between and/or among any of the other components.

Biocide Composition

As described herein, the composition of the present disclosure contains at least one isothiazolinone, at least one pyrithione, at least one zinc compound, and at least one organic amine.

A. Isothiazolinone

As described herein, the composition of the present disclosure contains at least one isothiazolinone, such as an isothiazolin-3-one. Isothiazolinones have been known to be effective against a broad range of microorganisms. In general, the isothiazolinone may be any type employed in the art and in particular one that provides a desired biocidal activity.

In one embodiment, the isothiazolinone may be a 2-alkyl-4-isothiazolin-3-one, 1,2-benzisothiazolin-3-one, or any combination thereof. It should be understood that the aforementioned isothiazolinones may be substituted or unsubstituted.

In one embodiment, the isothiazolinone may be at least one 2-alkyl-4-isothiazolin-3-one that can be substituted or unsubstituted. For instance, the isothiazolinone may be a 2-(C₄-C₁₀) alkyl-4-isothiazolin-3-one. Substituted 2-(C₄-C₁₀) alkyl-4-isothiazolin-3-ones may contain (C₁-C₄) alkyl groups or chloro substituents at one or both of the 4- and 5-positions of the isothiazoline ring.

In the 2-alkylisothiazolin-3-one, the alkyl radical denotes an n-alkyl, i-alkyl or c-alkyl radical. The alkyl radical may comprise 1 to 10, in particular 1 to 8, carbon atoms. Particular embodiments are 2-n-octylisothiazolin-3-one and 4,5-dichloro-2-n-octylisothiazolin-3-one.

In one embodiment, the isothiazolinone may be at least one substituted or unsubstituted 1,2-benzisothiazolin-3-one. For instance, if substituted, the substituent may be a C₁-C₁₀ alkyl, such as a C₁-C₆ alkyl, such as a C₂-C₅ alkyl, such as a C₄ alkyl.

For instance, in one embodiment, the isothiazolinone may comprise 1,2-benzisothiazolin-3-one (“BIT”), N-butyl-1,2-benzisothiazolin-3-one (“BBIT”), N-methyl-1,2-benzisothiazolin-3-one (“nMBIT”), 2-methyl-2H-isothiazol-3-one (“MIT”), 5-chloro-2-methyl-2H-isothiazol-3-one (“CMIT”), 2-octyl-3(2H)-isothiazolone (“OIT”), 4,5-dichloro-2n-octyl-3(2H)-isothiazolone (“DCOIT”), and/or 2,2-dithiobis(N-methylbenzamide) (“DTMB”).

In another embodiment, the isothiazolinone may comprise BIT, BBIT, MIT, OMIT, OIT, and/or DCOIT. In another embodiment, the isothiazolinone may comprise BIT, CMIT, and/or MIT. In another embodiment, the isothiazolinone may comprise MIT and/or CMIT.

In one embodiment, the isothiazolinone may comprise a fused benzyl ring. For instance, in one embodiment, the isothiazolinone may comprise BET, BBIT, nMBIT, or any combination thereof. In another embodiment, the isothiazolinone may comprise BIT, BBIT, or any combination thereof. In another particular embodiment, the isothiazolinone comprises BIT. In another particular embodiment, the isothiazolinone comprises BBIT.

Also, it should be understood that the aforementioned isothiazolinones may be used individually or in any combination.

B. Pyrithione

As described herein, the composition of the present disclosure contains at least one pyrithione. Pyrithiones have been known to be effective against a broad range of microorganisms. In general, the pyrithione may be any type employed in the art and in particular one that provides a desired biocidal activity.

For instance, the pyrithione may comprise sodium pyrithione, bismuth pyrithione, potassium pyrithione, lithium pyrithione, ammonium pyrithione, zinc pyrithione, copper pyrithione, calcium pyrithione, magnesium pyrithione, strontium pyrithione, silver pyrithione, gold pyrithione, manganese pyrithione, an organic amine pyrithione, or any combination thereof.

In another particular embodiment, the pyrithione may comprise aluminum pyrithione, ammonium pyrithione, barium pyrithione, bismuth pyrithione, cadmium pyrithione, calcium pyrithione, copper pyrithione, lithium pyrithione, magnesium pyrithione, manganese pyrithione, an organic amine pyrithione, potassium pyrithione, sodium pyrithione, tin pyrithione, zinc pyrithione, zirconium pyrithione, or any combination thereof. In another particular embodiment, the pyrithione may comprise copper pyrithione, sodium pyrithione, zinc pyrithione, or any combination thereof. In another particular embodiment, the pyrithione may comprise sodium pyrithione, zinc pyrithione, or any combination thereof.

In one particular embodiment, the pyrithione comprises sodium pyrithione. In another particular embodiment, the pyrithione comprises zinc pyrithione.

In this regard, as used herein, a pyrithione includes a pyrithione salt and/or a pyrithione acid. In one particular embodiment, the pyrithione includes a pyrithione salt. For instance, the pyrithione salt may be a monovalent metal salt of pyrithione or a polyvalent metal salt of pyrithione. In one particular embodiment, the pyrithione salt comprises a monovalent metal salt of pyrithione. In another particular embodiment, the pyrithione salt comprises a polyvalent metal salt of pyrithione.

In one particular embodiment, the pyrithione may be an alkali metal salt of pyrithione. For instance, the pyrithione may be lithium pyrithione, sodium pyrithione, potassium pyrithione, or any combination thereof. In another particular embodiment, the pyrithione may be sodium pyrithione.

Also, it should be understood that the aforementioned pyrithiones may be used individually or in any combination.

C. Zinc Compound

As described herein, the composition of the present disclosure contains at least one zinc compound. Without intending to be limited by theory, it is believed that the zinc compound can provide a source of metal ion in the biocide composition.

The zinc compound may be any zinc compound generally employed in the art. For instance, the zinc compound may be a zinc alloy, a zinc salt, a zinc oxide, a zinc hydroxide, or a combination thereof.

In one embodiment, the zinc salt may be a zinc salt of an organic acid and/or a zinc salt of an inorganic acid. In this regard, the zinc compound may be a zinc alloy, a zinc salt of an organic acid, a zinc salt of an inorganic acid, a zinc oxide, a zinc hydroxide, or a combination thereof.

In one embodiment, the zinc compound may comprise a zinc salt. In one particular embodiment, the zinc compound may comprise a zinc salt of an organic acid. In another particular embodiment, the zinc compound may comprise a zinc salt of an inorganic acid. In another embodiment, the zinc compound may comprise zinc oxide. In another embodiment, the zinc compound may comprise zinc hydroxide.

As indicated above, in one particular embodiment, the zinc compound may comprise a zinc salt of an inorganic acid. For instance, in one embodiment, the zinc compound may be zinc chloride.

In general, zinc salts include, but are not limited to, zinc acetate, zinc borate, zinc carbonate, basic zinc carbonate, zinc chloride, zinc sulfate, zinc citrate, zinc fluoride, zinc iodide, zinc lactate, zinc oleate, zinc oxalate, zinc phosphate, zinc propionate, zinc salicylate, zinc selenate, zinc silicate, zinc stearate, zinc sulfide, zinc sulfate, zinc tannate, zinc tartrate, zinc valerate, or any combination thereof.

In one embodiment, the zinc compound may be a binary zinc compound. For instance, the binary zinc compound may be zinc oxide, zinc sulfide, zinc halide (e.g., zinc fluoride, zinc iodide, zinc chloride, zinc bromide), zinc peroxide, zinc hydride, zinc carbide, zinc nitride, etc., or any combination thereof. In one particular embodiment, the binary zinc compound may be a zinc halide, such as a zinc chloride. In another embodiment, the binary zinc compound may be a zinc oxide.

Also, it should be understood that the aforementioned zinc compounds may be used individually or in any combination.

D. Organic Amine

As described herein, the composition of the present disclosure contains at least one organic amine. Without intending to be limited by theory, it is believed that the organic amine assists in the activity and the solubility of the pyrithione and the zinc compound. In addition, the organic amine may assist in helping the active ingredients be more available.

In one embodiment, the organic amine may have a formula as described in Formula 1 below.

NR¹R²R³ (Formula 1)

wherein

R¹, R², and R³ are individually hydrogen or a C₁₋₅ alkyl, optionally substituted, wherein at least one of R¹, R², and R³ is a C₁₋₅ alkyl, optionally substituted.

As indicated above, R¹, R², and R³ are individually hydrogen or a C₁₋₅ alkyl and at least one of R¹, R², and R³ is a C₁₋₅ alkyl, optionally substituted. In one embodiment, at least one of R¹, R², and R³ is hydrogen.

As indicated above, at least one of R¹, R², and R³ is a C₁₋₅ alkyl, such as a a C₁₋₄ alkyl, such as a C₁₋₃ alkyl, such as a C₁₋₂ alkyl. The alkyl may be a linear alkyl or a branched alkyl.

As indicated above, the alkyl may be substituted. For instance, the alkyl may have an alkoxy substitution and/or a hydroxyl substitution. For instance, the alkyl may have a C₁₋₄ alkoxy substitution, such as a C₁₋₃ alkoxy substitution, such as a C₁₋₂ alkoxy substitution, such as a C₁ alkoxy substitution or such as a C₂ alkoxy substitution. Other substitutions that may be of interest may include those that enhance water solubility.

In one embodiment, the alkyl has a hydroxyl substitution (e.g., —CH₂—CH₂—OH). In one embodiment, the alkoxy substitution may also contain a hydroxyl substitution. For instance, a carbon of the alkoxy group may have a hydroxyl substitution (e.g., —CH₂—CH₂—O—CH₂—CH₂—OH).

Examples of organic amines satisfying the aforementioned formula are as follows:

1) R¹═R²═R³═HO—CH₂—CH₂—;

2) R¹═R²═R³═HO—CH(CH₃)—CH₂—;

3) R¹═R²═CH₃— and R³═HO—CH₂—CH₂—;

4) R¹═R²═CH₃CH₂— and R³═HO—CH₂—CH₂—;

5) R¹═R²═CH₃CH₂CH₂— and R³═HO—CH₂—CH₂—;

6) R¹═R²CH₃CH₂CH₂CH₂— and R³═HO—CH₂—CH₂—;

7) R¹═R²═CH₃— and R³═HO—CH(CH₃)—CH₂—;

8) R¹═R²═CH₃CH₂— and R³═HO—CH(CH₃)—CH₂—;

9) R¹═R²═CH₃CH₂CH₂— and R³═HO—CH(CH₃)—CH₂—;

10) R¹═R²═CH₃CH₂CH₂CH₂— and R³═HO—CH(CH₃)—CH₂—;

11) R¹═R²═CH₃— and R³═HO—CH₂—CH₂—CH₂—,

12) R¹═R²═CH₃CH₂and R³═HO—CH₂—CH₂—CH₂—;

13) R¹═R²═CH₃CH₂CH₂— and R³═HO—CH₂—CH₂—CH₂—;

14) R¹═R²═CH₃CH₂CH₂CH₂— and R³═HO—CH₂—CH₂—CH₂—;

15) R¹═CH₃— and R²═R³═HO—CH₂—CH₂—;

16) R¹═CH₃CH₂— and R²═R³═HO—CH₂—CH₂—;

17) R¹═CH₃CH₂CH₂— and R²═R³═HO—CH₂—CH₂—;

18) R¹═CH₃CH₂CH₂CH₂— and R²═R³═HO—CH₂—CH₂—;

19) R¹═CH₃— and R²═R³═HO—CH(CH₃)—CH₂—;

20) R¹═CH₃CH₂— and R²═R³HO—CH(CH₃)—CH₂—;

21) R¹═CH₃CH₂CH₂— and R²═R³═HO—CH(CH₃)—CH₂—;

22) R¹═CH₃CH₂CH₂CH₂— and R²═R³═HO—CH(CH₃)—CH₂—,

23) R¹═CH₃— and R²═R³═HO—CH₂—CH₂—CH₂—;

24) R¹═CH₃CH₂— and R²═R³═HO—CH₂—CH₂—CH₂—;

25) R¹═CH₃CH₂CH₂— and R²═R³═HO—CH₂—CH₂—CH₂—;

26) R¹═CH₃CH₂CH₂CH₂— and R²═R³═HO—CH₂—CH₂—CH₂—;

27) R¹═H— and R²═R³═HO—CH₂—CH₂—;

28) R¹═H— and R²═R³═HO—CH(CH₃)—CH₂—;

29) R¹═H— and R²═R³═HO—CH₂—CH₂—CH₂—;

30) R¹═R²═H— and R³═HO—CH₂—CH₂—;

31) R¹═R²═H— and R³═HO—CH₂—CH₂—CH₂—;

32) R¹═R²═H— and R³═HO—CH(CH₃)—CH₂—;

33) R¹═R²═H— and R³═HO—CH₂—C(CH₃)₂—;

34) R¹═R²═H— and R³═HO—C(CH₃)₂—CH₂—;

35) R¹═CH₃—, R²═H— and R³═HO—CH₂—CH₂—;

36) R¹═CH₃—, R²═H— and R³═HO—CH₂—CH₂—CH₂—;

37) R¹═CH₃—, R²═H— and R³═HO—CH(CH₃)—CH₂—;

38) R¹═CH₃—, R²═H— and R³═HO—CH₂—C(CH₃)₂—;

39) R¹═CH₃—, R²═H— and R³═HO—C(CH₃)₂—CH₂—;

40) R¹═CH₃—CH₂—, R²═H— and R³═HO—CH₂—CH₂—;

41) R¹═CH₃—CH₂—, R²═H— and R³═HO—CH₂—CH₂—CH₂—;

42) R¹═CH₃—CH₂—, R⁴═H— and R³═HO—CH(CH₃)—CH₂—;

43) R¹═CH₃—CH₂—, R²═H— and R³═HO—CH₂—C(CH₃)₂—;

44) R¹═CH₃—CH₂—, R²═H— and R³═HO—C(CH₃)₂—CH₂—;

45) R¹═CH₃—CH₂—CH₂—, R²═H— and R³═HO—CH₂—CH₂—;

46) R¹═CH₃—CH₂—CH₂—, R²═H— and R³═HO—CH₂—CH₂—CH₂—;

47) R¹═CH₃—CH₂—CH₂—, R²═H— and R³═HO—CH(CH₃)—CH₂—;

48) R¹═CH₃—CH₂—CH₂—, R²═H— and R³═HO—CH₂—C(CH₃)₂—;

49) R¹═CH₃—CH₂—CH₂—, R²═H— and R³═HO—C(CH₃)₂—CH₂—;

50) R¹═C(CH₃)₂—, R²═H— and R³═HO—CH₂—CH₂—;

51) R¹═C(CH₃)₂—, R²═H— and R³═HO—CH₂—CH₂—CH₂—;

52) R¹═C(CH₃)₂—, R²═H— and R³═HO—CH(CH₃)—CH₂—;

53) R¹═C(CH₃)₂—, R²═H— and R³═HO—CH₂—C(CH₃)₂—;

54) R¹═C(CH₃)₂—, R²═H— and R³═HO—C(CH₃)₂—CH₂—;

55) R¹═R²═CH₃— and R³═HO—CH₂—C(CH₃)₂—;

56) R¹═R²═H— and R³═(HOCH₂)₂C(CH₂CH₃);

57) R¹═R²═H— and R³═HO—CH₂—CH₂—O—CH₂—CH₂—;

58) R¹H and R²═CH₃— and R³═HO—CH₂—CH₂—O—CH₂—CH₂—;

59) R¹═R²═CH₃— and R³═HO—CH₂—CH₂—O—CH₂—CH₂—;

In one particular embodiment, the organic amine comprises an alkanolamine. For instance, the organic amine may comprise a 1,2 alkanolamine and/or a 1,3 alkanolamine. In one embodiment, the alkanolamine may have the following formula:

R⁴NH—(CHR⁵)ₙ—CHR⁶—OH (Formula 2)

wherein

n is 1 or 2;

R⁴, R⁵ and R⁶are individually hydrogen or a C₁₋₅ alkyl,

As indicated above, n may be 1 or 2. In one embodiment, n is 1. In another embodiment, n is 2.

As indicated above, R⁴, R⁵ and R⁶ are individually hydrogen or a C₁₋₅ alkyl. In one embodiment, at least one of R⁴, R⁵ and R⁶ is hydrogen. In another embodiment, at least two of R⁴, R⁵ and R⁶ are hydrogen. In another embodiment, R⁴, R⁵ and R⁶ are hydrogen.

In one embodiment, at least one of one of R⁴, R⁵ and R⁶ is a C₁₋₅ alkyl, such as a C₁₋₄ alkyl, such as a C₁₋₃ alkyl, such as a C₁₋₂ alkyl. The alkyl may be a linear alkyl or a branched alkyl.

The organic amine may have any combination of n, R⁴, R⁵ and R⁶ as defined herein. For instance, they may be as follows:

| R⁴ | R⁵ | R⁶ | n |
|---|---|---|---|
| H | H | H | 1 or 2 |
| CH₃ | H | H | 1 or 2 |
| C₂H₅ | H | H | 1 or 2 |
| n-C₃H₇ | H | H | 1 or 2 |
| i-C₃H₇ | H | H | 1 or 2 |
| H | CH₃ | H | 1 or 2 |
| H | H | CH₃ | 1 or 2 |

The organic amine may include, but are not limited to, ethanolamine, 1-amino-2-propanol, 3-amino-1-propanol, 2-(methylamino)ethanol, 2-(ethylamino)ethanol, 2(propylamino)ethanol, 2(isopropylamino)ethanol, diethanolamine, triethanolamine, diisopropanolamine, triisopropanolamine, 2-amino-2-methyl-1-propanol (also called AMP), 2-amino-2-ethyl-1,3-propanediol (also called AEPD), 2(2-aminoethoxy)ethanol (also called diglycol amine), N-methyldiethanolamine, N,N-dimethylethanolamine, N,N-diethylethanolamine, N,N-dibutylaminoethanol, N,N dimethylamino-2-propanol, etc. The organic amines may be used individually or in any combination.

In one particular embodiment, the organic amine may comprise ethanolamine, 1-amino-2-propanol, 3-amino-1-propanol, 2-(methylamino)ethanol, 2-(n-propylamino)ethanol, 2-(ethylamino) ethanol, 2-(isopropylamino)ethanol, and combinations thereof. In another particular embodiment, the organic amine may comprise ethanolamine.

In addition to the aforementioned amines, the biocide composition may include a second organic amine. For instance, the second organic amine may be one or more amines selected from the group consisting of monomers and polymers of alkyl diamines of Formula 3 below may be used in conjunction with the aforementioned amines.

R⁷R⁸N—[(CH₂)ₚ—CH₂—NH—]_{q}—H (Formula 3)

wherein

R⁷ and R⁸ are individually hydrogen or a C₁₋₅ alkyl, optionally substituted,

p is 1 or 2,

q is from about 1 to about 2000.

As indicated above, R⁷ and R⁸ are individually hydrogen or a C₁₋₅ alkyl. In one embodiment, at least one of R⁷ and R⁸ are is hydrogen. As indicated above, at least one of R⁷ and R⁸ are is a C₁₋₅ alkyl, such as a C₁₋₄ alkyl, such as a C₁₋₃ alkyl, such as a C₁₋₂ alkyl. The alkyl may be a linear alkyl or a branched alkyl.

As indicated above, p may be 1 or 2. In one embodiment, p is 1. In another embodiment, p is 2.

As indicated above, q may be from 1 to about 2000. In this regard, q may be any integer between and including 1 and 2000. In one embodiment, q may be 1. In another embodiment, q may be 2. In another embodiment, q may be 3.

Examples of amines satisfying the aforementioned formula are as follows:

1) R⁷═R⁸═CH₂—; p=2, q=2;

2) R⁷═R⁸═CH₃CH₂—; p=2; q=1;

3) R⁷═R⁸═H; p=1; q=1;

4) R⁷═R⁸═H; p=1; q=2;

5) R⁷═R⁸═H; p=1; q=3.

The amine of Formula 3 may include, but is not limited to, 1,3-diaminopropane, diethylenetriamine, triethylenetetraamine, polyethylene imine, diethylamino propylamine, dimethylaminopropylamine, or any combination thereof.

Also, it should be understood that the aforementioned organic amines may be used individually or in any combination.

E. Other Additives

In addition to the above, the composition, whether biocide composition or coating composition disclosed herein, may include any other additives or components generally employed in the art.

For instance, these additives may include surfactants (e.g., cationic, anionic, zwitterionic), processing additives, UV stabilizers, dyes, pigments, anti-settling agents, wetting agents, thickening agents, antifoaming agents, organic acids, phenols, pH adjusters (e.g., acid or base), etc.

In addition, the additives may also include a polymer. In one embodiment, the composition may comprise a polymer. For instance the polymer may be acrylic and substituted methacrylates, styrene/butadiene, ethylene vinyl acetate, polyvinyl acetate, styrene/butadiene/N-methylol acrylamide, nitrile, and copolymers thereof. In one embodiment, the polymer may be an acrylic polymer or copolymer. However, additional polymers known in the paint and coating arts may also be employed in the composition disclosed herein.

In addition, the additives may also include a solvent. In one embodiment, the composition may comprise a solvent. Solvents include, but are not limited to, water and/or an organic solvent. For instance, the solvent may include a combination of water and an organic solvent. The organic solvent includes, but is not limited to alcohols, such as methanol, ethanol, glycols, ethers, and esters.

In one embodiment, a pH adjuster may be employed. The pH adjuster may be any type typically employed in the art. For instance, the pH adjuster may be an acid or a base. For instance, if it is desired to create an alkaline condition, a base may be employed. The base may be a hydroxide, such as sodium hydroxide or potassium hydroxide. Without intending to be limited by theory, the pH adjuster may be employed to assist in increase the solubility of an active ingredient.

In one embodiment, the composition may be essentially free of formaldehyde and/or a formaldehyde releasing agent. For instance, the composition may contain the formaldehyde and/or a formaldehyde releasing agent in an amount of less than 0.1 wt. %, such as less than 0.05 wt. %.

In one embodiment, the composition may be essentially free of a surfactant. For instance, the composition may be free of an anionic surfactant, such as one having a sulfate or sulfonate moiety and/or one being an alkylaryl sulfonic acid or salt thereof. For instance, the composition may contain such surfactant in an amount of less than 0.1 wt. %, such as less than 0.05 wt. %.

Formulation

The biocide composition of the present disclosure can be provided in a ready to use formulation or alternatively, as a concentrate. As a concentrate, upon dilution with water, a working biocide composition can be obtained that exhibits a desired antimicrobial efficacy.

In general, the biocide composition comprises an isothiazolinone, a pyrithione, a zinc compound, and an organic amine. The composition may also comprise any of the aforementioned optional additives.

In general, the biocide composition may contain the isothiazolinone in an amount of 0.0001 wt. % or more, such as 0.0005 wt. % or more, such as 0.0.007 wt. % or more, such as 0.001 wt. % or more, such as 0.0012 wt. % or more, such as 0.0015 wt. % or more, such as 0.01 wt. % or more, such as 0.05 wt. % or more, such as 0.1 wt. % or more, such as 0.25 wt. % or more, such as 0.5 wt. % or more, such as 1 wt. % or more, such as 1.5 wt. % or more. The biocide composition may contain the isothiazolinone in an amount of about 20 wt. % or less, such as 10 wt. % or less, such as 7.5 wt. % or less, such as 5 wt. % or less, such as 3 wt. % or less, such as 2 wt. % or less, such as 1 wt. % or less, such as 0.5 wt. % or less, such as 0.25 wt. % or less, such as 0.1 wt. % or less, such as 0.05 wt. % or less, such as 0.011 wt. % or less, such as 0.01 wt. % or less, such as 0.09 wt. % or less, such as 0.008 wt. % or less, such as 0.006 wt. % or less, such as 0.005 wt. % or less, such as 0,001 wt. % or less, based on the total weight of the composition. For instance, the biocide composition may contain the isothiazolinone in an amount of from 0.0001 wt. % to 10 wt. %, such as from 0.0001 wt. % to 5 wt. %, such as from 0.001 wt. % to 5 wt. %, such as from 0.001 to 2.5 wt. %, such as from 0.25 wt. % to 3 wt. %, based on the weight of the composition.

In general, the biocide composition may contain the pyrithione in an amount of 0.0001 wt. % or more, such as 0,001 wt. % or more, such as 0.0015 wt. % or more, such as 0.002 wt. % or more, such as 0.0025 wt. % or more, such as 0.003 wt. % or more, such as 0.005 wt. % or more, 0.01 wt. % or more, such as 0.05 wt. % or more, such as 0.1 wt. % or more, such as 0.25 wt. % or more, such as 0.5 wt. % or more, such as 1 wt. % or more, such as 1,5 wt. % or more. The biocide composition may contain the pyrithione in an amount of about 20 wt. % or less, such as 10 wt. % or less, such as 7.5 wt. % or less, such as 5 wt. % or less, such as 3 wt. % or less, such as 2 wt. % or less, such as 1 wt. % or less, such as 0.5 wt. % or less, such as 0.25 wt. % or less, such as 0.1 wt. % or less, such as 0.05 wt. % or less, such as 0.01 wt. % or less, such as 0.006 wt. % or less, such as 0,005 wt. % or less, such as 0.004 wt. % or less, such as 0.003 wt. % or less, such as 0.001 wt. % or less, based on the total weight of the composition. For instance, the biocide composition may contain the pyrithione in an amount of from 0.0001 wt. % to 10 wt. %, such as from 0.0001 wt. % to 5 wt. %, such as from 0.001 wt. % to 5 wt. %, such as from 0.001 to 2.5 wt. %, such as from 0.25 wt. % to 3 wt. %, based on the weight of the composition.

In general, the biocide composition may contain the zinc compound in an amount of 0.0001 wt. % or more, such as 0.001 wt. % or more, such as 0.005 wt. % or more, such as 0.01 wt. % or more, such as 0.05 wt. % or more, such as 0.1 wt. % or more, such as 0.25 wt. % or more, such as 0.5 wt. % or more, such as 1 wt. % or more, such as 1.5 wt. % or more. The biocide composition may contain the zinc compound in an amount of about 10 wt. % or less, such as 5 wt. % or less, such as 4 wt. % or less, such as 3 wt. % or less, such as 2 wt. % or less, such as 1 wt. % or less, such as 0.5 wt. % or less, such as 0.25 wt. % or less, such as 0.1 wt. % or less, such as 0.05 wt. % or less, such as 0.01 wt. % or less, such as 0.005 wt. % or less, such as 0.001 wt. % or less, based on the total weight of the composition. For instance, the biocide composition may contain the zinc compound in an amount of from 0.0001 wt. % to 10 wt. %, such as from 0.0001 wt. % to 5 wt. %, such as from 0.001 wt. % to 5 wt. %, such as from 0.001 to 2.5 wt. %, such as from 0.001 wt. % to 1 wt. %, based on the weight of the composition.

In general, the biocide composition may contain the organic amine in an amount of 1 wt. % or more, such as 5 wt. % or more, such as 10 wt. % or more, such as 15 wt. % or more, such as 20 wt. % or more, such as 30 wt. % or more, based on the weight of the composition. The biocide composition may contain the organic amine in an amount of 90 wt. % or less, such as 85 wt. % or less, such as 80 wt. % or less, such as 70 wt. % or less, such as 60 wt. % or less, such as 50 wt. % or less, such as 40 wt. % or less, such as 30 wt. % or less, based on the weight of the composition. For instance, the biocide composition may contain the organic amine in an amount of from 1 wt. % to 85 wt. %, such as from 5 wt. % to 80 wt. %, such as from 5 wt. % to 60 wt. %, such as from 5 wt. % to 50 wt. %, such as from 5 wt. % to 40 wt. %, based on the weight of the composition.

In general, the biocide composition may contain a solvent in an amount of 1 wt. % or more, such as 5 wt. % or more, such as 10 wt. % or more, such as 15 wt. % or more, such as 20 wt. % or more, such as 25 wt. % or more, based on the weight of the composition. The biocide composition may contain the solvent in an amount of 90 wt. % or less, such as 80 wt. % or less, such as 60 wt. % or less, such as 50 wt. % or less, such as 40 wt. % or less, such as 30 wt. % or less, based on the weight of the composition. For instance, the biocide composition may contain the solvent in an amount of from 1 wt. % to 90 wt. %, such as from 5 wt. % to 60 wt %, such as from 10 wt. % to 50 wt. %, such as from 15 wt. % to 40 wt. %, such as from 20 wt. % to 30 wt. %, based on the weight of the composition.

In general, the biocide composition may contain a pH adjuster in an amount of 0.0001 wt. % or more, such as 0.001 wt. % or more, such as 0.005 wt. % or more. such as 0.01 wt. % or more, such as 0.05 wt. % or more, such as 0.1 wt. % or more, such as 0.25 wt. % or more, such as 0.5 wt. % or more, such as 1 wt. % or more, based on the weight of the composition. The biocide composition may contain the pH adjuster in an amount of 5 wt. % or less, such as 3 wt. % or less, such as 2 wt. % or less, such as 1 wt. % or less, such as 0.75 wt. % or less, based on the total weight of the composition. For instance, the biocide composition may contain the pH adjuster in an amount of from 0.0001 wt. % to 5 wt. %, such as from 0.001 wt. % to 3 wt. %, such as from 0.01 wt. % to 2 wt. %, such as from 0.1 to 1 wt. %, such as from 0.25 wt. % to 0.75 wt. %, based on the weight of the composition.

In one embodiment, the ratio of the weight percentage of the pyrithione to the isothiazolinone may be within a certain range. For instance, the ratio of the weight percentage of the pyrithione to the isothiazolinone may be about 0.1 or more, such as about 0.25 or more, such as about 0.5 or more, such as about 1 or more, such as about 1.5 or more, such as about 1.75 or more. The ratio of the weight percentage of the pyrithione to the isothiazolinone may be about 10 or less, such as 5 or less, such as 4 or less, such as 3.5 or less, such as 3 or less, such as 2.5 or less, such as 2.25 or less.

In one embodiment, the ratio of the weight percentage of the isothiazolinone to the zinc compound may be within a certain range. For instance, the ratio of the weight percentage of the isothiazolinone to the zinc compound may be about 0.005 or more, such as 0.006 or more, such as 0.01 or more, such as 0.02 or more, such as 0.04 or more, such as 0.05 or more, such as 0.1 or more, such as 0.25 or more, such as 0.33 or more, such as 0.5 or more, such as 0.75 or more. The ratio of the weight percentage of the isothiazolinone to the zinc compound may be about 200 or less, such as 150 or less, such as 125 or less, such as 100 or less, such as 75 or less, such as 50 or less, such as 25 or less, such as 15 or less, such as 10 or less, such as 5 or less, such as 2.5 or less, such as 2 or less.

As indicated herein, the composition may be first formulated as a concentrate which can then be diluted and added to a final product. The relative amounts of the different components can vary significantly based on many factors. The concentrate may comprise an isothiazolinone, a pyrithione, a zinc compound, and an organic amine. The concentrate may also comprise any of the aforementioned optional additives.

The weight ratios and weight percentages of the components within the concentrate may also be within the values presented herein. For instance, the ratio of the weight percentage of the pyrithione to the isothiazolinone and the ratio of the weight percentage of the isothiazolinone to the zinc compound may be the same as the ratios presented for the composition above.

Applications

The biocide composition disclosed herein may be employed for various applications. For instance, the applications (or end-use formulations) include, but are not limited to, polymer latex, paints, polymer emulsion, coatings, adhesives, sealants, caulks, mineral and pigment slurries, printing inks, household products, personal care products, metal working fluids, leather and hide treatment products, etc.

In this regard, the present invention is also directed to an end-use formulation containing the biocide composition disclosed herein. For instance, such end-use formulation may contain the components of the biocide composition in the aforementioned amounts. Thus, while the concentrations herein are based on the weight of the biocide composition, the concentrations in another embodiment may also be based on the weight of the end-use formulation. Alternatively, the concentrations may also be based on the total weight of the isothiazolinone, pyrithione, zinc compound, and organic amine.

In on embodiment, the biocide composition may be present within the end-use formulation in an amount of from 0.01 wt. % to 5 wt. %, such as from 0.01 wt. % to 2.5 wt. %, such as from 0.025 wt. % to 1 wt. %, such as from 0.05 wt. % to 0.5 wt. %, based on the total weight of the end-use formulation.

Accordingly, in one embodiment, the present disclosure is also directed to a method of preserving a substrate. The method may comprise a step of applying the biocide composition to the substrate. The composition may be applied using any method known in the art such as, but not limited to, brushing, spraying, sponging, dipping, soaking, etc. The amount applied to the substrate may be depending upon the desired biocidal effect. For instance, the amount applied may be “an effective biocidal amount” which may refer to an amount that has a positive effect on reducing, eliminating, or preventing the attachment or growth of microbes on a substrate.

The method may also require drying the composition on the substrate. In an embodiment wherein the biocide composition is provided within or as a coating composition, the method may comprise a step of applying the coating composition to the substrate.

When provided as a coating composition, the biocide composition may be present within the coating composition in an amount of from 0.01 wt. % to 5 wt. %, such as from 0.01 wt. % to 2.5 wt. %, such as from 0.025 wt. % to 1 wt. %, such as from 0.05 wt. % to 0.5 wt. %, based on the total weight of the coating composition. The coating composition is formed by combining the biocide composition, or the individual components alone or in any combination, and additives into a paint base material. Methods of forming such coating compositions are well known in the art.

In general, the substrate may be any substrate generally known in the art. In particular, the substrate may be one in which it is desired to inhibit or control the growth of microorganisms. For instance, the substrate may be wood, a metal, a plastic (e.g., vinyl), concrete, etc. In this regard, the present disclosure may also be directed to a coated substrate comprising the biocide composition and/or coating composition disclosed herein. The coated substrate is expected to exhibit biocidal properties which it is coated in order to prevent, inhibit, or treat for the attachment or growth of microbes on the substrate.

One advantage of the composition disclosed herein is the increased protection against a large spectrum of microbes. Various different microorganisms may be killed and/or controlled in accordance with the present disclosure. For instance, the composition of the present disclosure can control gram positive bacteria, gram negative bacteria, and the like. In addition to bacteria, the composition of the present disclosure can also kill and/or control the growth of various other microorganisms, such as fungi, yeast, and the like. Examples of particular microorganisms that may be killed and/or controlled in accordance with the present disclosure include Staphylococcus aureus, Streptococcus pneumoniae, Pseudomonas aeruginosa, Serratia marcescens, Salmonella enteriticlis, Neisseria gonorrhoeae, Escherichia coli, Enterococcus hirae, Acinetobacter baumannii, Acinetobacter calcoaceticus, Listeria monocytogenes, Enterobacter gergoviae, Enterobacter cloacae, Klebsiella pneumoniae, Burholderia cepacia, Pseudomonas putida, Kocuria rhizophila, Candida albicans, Saccharomyces cerevisiae, Aspergillus brasiliensis, Penicillium funiculosum, Eupenicillium levitum, Bacillus cereus, Bacillus subtilis, Clostridium difficile, Clostridium perfringens, or mixtures thereof.

In one particular embodiment, the microorganism comprises a gram positive bacteria. In another particular embodiment, the microorganism comprises a gram negative bacteria.

The present disclosure may be better understood with reference to the following example.

### EXAMPLES

The examples of the invention are given below by way of illustration and not by way of limitation. The following experiments were conducted in order to show some of the benefits and advantages of the present invention.

### Example 1

In this Example, challenge testing was conducted using a paint formulation. The paint was prepared initially with no added in-can preservative. Aliquots of the unpreserved paint were dispensed into pre-sterilized containers. Ladders of samples with increasing concentrations of various biocide preparations were prepared by spiking the unpreserved paint samples.

A first set of the ladder samples were treated with a commercially available (Sodium Omadine® 2000 Antimicrobial; 10% NaPT—Sodium Pyrithione active agent) biocide preparation of a pyrithione biocide enhanced by zinc metal ions and an organic amine (NaPT2000 only controls).

A second set of ladder samples were treated with a commercially available (Proxel® AQ Preservative; 9.25% BIT—1₉2-benzisothiazolin-3-one active agent) BIT based biocide preparation (BIT only controls).

A third set of the ladder samples were treated with the inventive formulation in which BIT was added into a biocide preparation of a pyrithione biocide enhanced by zinc metal ions and an organic amine. The resulting active agent concentrations were: 4% Sodium Pyrithione active agent and 2% BIT active agent (NaPT/BIT/MEA/ZnCl prototype test samples).

One sample of unpreserved paint was left untreated with no added biocide (blank control).

The following bacteria were utilized for the challenge test:

| | American Type Culture Collection |
|---|---|
| Organism | (“ATCC”) Number |
| Pseudomonas aeruginosa | 10145 |
| Enterobacter cloacae | 7256 |
| Escherichia coli | 11229 |
| Acinetobacter calcoaceticus | 14987 |

The bacterial spoilage microorganisms were adapted to grow on agar plates adjusted to pH 9. Lawns of the test bacteria were harvested from Trypticase Soy Agar (TSA) plates using a small amount of sterile dilution water. The resulting bacterial suspension was used as the inoculum for challenge testing. For the first inoculation the amount of bacterial suspension added was 10% of the volume of the paint sample. The amount of bacterial suspension added was 5% of the volume of the paint sample for the second challenge and 2.5% of the volume of the paint sample for the third challenge.

The efficacy of the preservative in controlling contamination was monitored at 72 hours after inoculation by plating the samples on plates of TSA. TSA plates were evaluated following incubation at 30° C. for 2 days. These “streak” plates were ranked from 0 to 5 according to the degree of microbial contamination as described below.

TABLE 1
Assessment of Contamination Based on Level of Growth

| Level | | |
|---|---|---|
| of Growth | No. of Microorganisms | Degree of Contamination |
| 0 | No growth | Not contaminated |
| 1 | 1-5 viable microorganisms | Very lightly contaminated |
| 2 | 6-15 viable microorganisms | Lightly contaminated |
| 3 | 16-30 viable microorganisms | Moderately contaminated |
| 4 | 31-45 viable microorganisms | Heavily contaminated |
| 5 | >45 viable microorganisms | Severely contaminated |

TABLE 2
Concentration of Samples

| | | | NaPT | BIT | NaPT + | | |
|---|---|---|---|---|---|---|---|
| Sample | Dosage | Sample | (ppm | (ppm | BIT | MEA | ZnCl₂ |
| No. | (ppm) | Description | ai) | ai) | (ppm ai) | (ppm) | (ppm) |
| 1 | 0 | Blank | 0 | 0 | 0 | 0 | 0 |
| 2 | 98 | NaPT/MEA/ | 9.8 | — | 9.8 | | |
| | | ZnCl₂ | | | | | |
| 3 | 157 | NaPT/MEA/ | 15.7 | — | 15.7 | | |
| | | ZnCl₂ | | | | | |
| 4 | 208 | NaPT/MEA/ | 20.8 | — | 20.8 | | |
| | | ZnCl₂ | | | | | |
| 5 | 490 | NaPT/MEA/ | 49.0 | — | 49.0 | | |
| | | ZnCl₂ | | | | | |
| 6 | 613 | NaPT/MEA/ | 61.3 | — | 61.3 | | |
| | | ZnCl₂ | | | | | |
| 7 | 1103 | NaPT/MEA/ | 110 | — | 110.0 | | |
| | | ZnCl₂ | | | | | |
| 8 | 1593 | NaPT/MEA/ | 159 | — | 159.0 | | |
| | | ZnCl₂ | | | | | |
| 9 | 2205 | NaPT/MEA/ | 221 | — | 221.0 | | |
| | | ZnCl₂ | | | | | |
| 10 | 247 | BIT | — | 22.8 | 22.8 | 0 | 0 |
| 11 | 396 | BIT | — | 36.6 | 36.6 | 0 | 0 |
| 12 | 525 | BIT | — | 48.6 | 48.6 | 0 | 0 |
| 13 | 1236 | BIT | — | 114 | 114.0 | 0 | 0 |
| 14 | 1545 | BIT | — | 143 | 143.0 | 0 | 0 |
| 15 | 2781 | BIT | — | 257 | 257.0 | 0 | 0 |
| 16 | 4017 | BIT | — | 372 | 372.0 | 0 | 0 |
| 17 | 5562 | BIT | — | 515 | 515.0 | 0 | 0 |
| 18 | 158 | NaPT/BIT/ | 6.3 | 3.2 | 9.5 | 101.1 | 2.8 |
| | | MEA/ZnCl₂ | | | | | |
| 19 | 253 | NaPT/BIT/ | 10.1 | 5.1 | 15.2 | 161.9 | 4.6 |
| | | MEA/ZnCl₂ | | | | | |
| 20 | 336 | NaPT/BIT/ | 13.4 | 6.7 | 20.1 | 215.0 | 6.0 |
| | | MEA/ZnCl₂ | | | | | |
| 21 | 791 | NaPT/BIT/ | 31.6 | 15.8 | 47.4 | 506.2 | 14.2 |
| | | MEA/ZnCl₂ | | | | | |
| 22 | 988 | NaPT/BIT/ | 39.5 | 19.8 | 59.3 | 632.3 | 17.8 |
| | | MEA/ZnCl₂ | | | | | |
| 23 | 1100 | NaPT/BIT/ | 44.0 | 22.0 | 66.0 | 704.0 | 19.8 |
| | | MEA/ZnCl₂ | | | | | |

TABLE 3
Challenge Testing Results

| | | | 1^{st} | 2^{nd} | 3^{rd} | |
|---|---|---|---|---|---|---|
| | | | Chal- | Chal- | Chal- | |
| Sample | Dosage | Sample | lenge | lenge | lenge | |
| No. | (ppm) | Description | 72 hour | 72 hour | 72 hour | Status |
| 1 | 0 | Blank | 5 | 5 | 5 | Fail |
| 2 | 98 | NaPT/ | 5 | 5 | 5 | Fail |
| | | MEA/ZnCl₂ | | | | |
| 3 | 157 | NaPT/ | 5 | 5 | 5 | Fail |
| | | MEA/ZnCl₂ | | | | |
| 4 | 208 | NaPT/ | 5 | 5 | 5 | Fail |
| | | MEA/ZnCl₂ | | | | |
| 5 | 490 | NaPT/ | 0 | 0 | 5 | Fail |
| | | MEA/ZnCl₂ | | | | |
| 6 | 613 | NaPT/ | 0 | 0 | 0 | Pass |
| | | MEA/ZnCl₂ | | | | |
| 7 | 1103 | NaPT/ | 0 | 0 | 0 | Pass |
| | | MEA/ZnCl₂ | | | | |
| 8 | 1593 | NaPT/ | 0 | 0 | 0 | Pass |
| | | MEA/ZnCl₂ | | | | |
| 9 | 2205 | NaPT/ | 0 | 0 | 0 | Pass |
| | | MEA/ZnCl₂ | | | | |
| 10 | 247 | BIT | 5 | 5 | 5 | Fail |
| 11 | 396 | BIT | 4 | 5 | 5 | Fail |
| 12 | 525 | BIT | 0 | 2 | 5 | Fail |
| 13 | 1236 | BIT | 0 | 0 | 0 | Pass |
| 14 | 1545 | BIT | 0 | 0 | 0 | Pass |
| 15 | 2781 | BIT | 0 | 0 | 0 | Pass |
| 16 | 4017 | BIT | 0 | 0 | 0 | Pass |
| 17 | 5562 | BIT | 0 | 0 | 0 | Pass |
| 18 | 158 | NaPT/BIT/ | 5 | 5 | 5 | Fail |
| | | MEA/ZnCl₂ | | | | |
| 19 | 253 | NaPT/BIT/ | 5 | 5 | 5 | Fail |
| | | MEA/ZnCl₂ | | | | |
| 20 | 336 | NaPT/BIT/ | 5 | 5 | 5 | Fail |
| | | MEA/ZnCl₂ | | | | |
| 21 | 791 | NaPT/BIT/ | 0 | 0 | 0 | Pass |
| | | MEA/ZnCl₂ | | | | |
| 22 | 988 | NaPT/BIT/ | 0 | 0 | 0 | Pass |
| | | MEA/ZnCl₂ | | | | |
| 23 | 1100 | NaPT/BIT/ | 0 | 1 | 0 | Pass |
| | | MEA/ZnCl₂ | | | | |

TABLE 4
Weight Ratios and Percentages of Components of Samples

| | | NaPT | BIT | NaPT + BIT |
|---|---|---|---|---|
| Sample | NaPT/BIT | (% of | (% of | (% of |
| No. | (wt. ratio) | dosage) | dosage) | dosage) |
| 1 | — | — | — | — |
| 2 | — | 10.00 | — | 10.00 |
| 3 | — | 10.00 | — | 10.00 |
| 4 | — | 10.00 | — | 10.00 |
| 5 | — | 10.00 | — | 10.00 |
| 6 | — | 10.00 | — | 10.00 |
| 7 | — | 9.97 | — | 9.97 |
| 8 | — | 9.98 | — | 9.98 |
| 9 | — | 10.02 | — | 10.02 |
| 10 | — | — | 9.23 | 9.23 |
| 11 | — | — | 9.24 | 9.24 |
| 12 | — | — | 9.26 | 9.26 |
| 13 | — | — | 9.22 | 9.22 |
| 14 | — | — | 9.26 | 9.26 |
| 15 | — | — | 9.24 | 9.24 |
| 16 | — | — | 9.26 | 9.26 |
| 17 | — | — | 9.26 | 9.26 |
| 18 | 1.97 | 3.99 | 2.03 | 6.01 |
| 19 | 1.98 | 3.99 | 2.02 | 6.01 |
| 20 | 2.00 | 3.99 | 1.99 | 5.98 |
| 21 | 2.00 | 3.99 | 2.00 | 5.99 |
| 22 | 1.99 | 4.00 | 2.00 | 6.00 |
| 23 | 2.00 | 4.00 | 2.00 | 6.00 |

The passing level of NaPT alone as Sodium Omadine 2000 was 61 ppm NaPT. The passing level of BIT alone as Proxel AQ was 114 ppm BIT. Meanwhile, the passing level of NaPT and BIT as a blend was 32 ppm NaPT+16 ppm BIT.

The results demonstrate a synergistic effect of the components employed within the composition.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part.

Furthermore, those of ordinary skill in the art will appreciate that the foregoing description is by way of example only, and is not intended to limit the invention so further described in such appended claims.

1. A biocide composition comprising:
an isothiazolinone,
a pyrithione,
a zinc compound, and
an organic amine.

2. The biocide composition of claim 1, wherein the isothiazolinone comprises 1,2-benzisothiazolin-3-one, N-butyl-1,2-benzisothiazolin-3-one, N-methyl-1,2-benzisothiazolin-3-one, 2-methyl-2H-isothiazol-3-one, 5-chloro-2-methyl-2H-isothiazol-3-one, 2-octyl-3(2H)-isothiazolone, 4,5-dichloro-2n-octyl-3(2H)-isothiazolone, 2,2-dithiobis(N-methylbenzamide), or any combination thereof.

3. The biocide composition of claim 2, wherein the isothiazolinone comprises 1,2-benzisothiazolin-3-one, N-butyl-1,2-benzisothiazolin-3-one, or any combination thereof.

4. The biocide composition of claim 3, wherein the isothiazolinone comprises 1,2-benzisothiazolin-3-one.

5. The biocide composition of claim 1, wherein the pyrithione comprises sodium pyrithione, bismuth pyrithione, potassium pyrithione, lithium pyrithione, ammonium pyrithione, zinc pyrithione, copper pyrithione, calcium pyrithione, magnesium pyrithione, strontium pyrithione, silver pyrithione, gold pyrithione, manganese pyrithione, an organic amine pyrithione, or any combination thereof.

6. The biocide composition of claim 5, wherein the pyrithione comprises sodium pyrithione.

7. The biocide composition of claim 1, wherein the pyrithione comprises an alkali metal salt of pyrithione.

8. The biocide composition of claim 1, wherein the zinc compound comprises a zinc salt of an organic acid, a zinc salt of an inorganic acid, a zinc oxide, a zinc hydroxide, or any combination thereof.

9. The biocide composition of claim 8, wherein the zinc compound comprises a zinc salt of an inorganic acid.

10. The biocide composition of claim 9, wherein the zinc compound comprises zinc chloride.

11. The biocide composition of claim 1, wherein the zinc compound comprises a zinc salt selected from the group consisting of zinc acetate, zinc borate, zinc bromide, zinc carbonate, basic zinc carbonate, zinc chloride, zinc sulfate, zinc citrate, zinc fluoride, zinc iodide, zinc lactate, zinc oleate, zinc oxalate, zinc phosphate, zinc propionate, zinc salicylate, zinc selenate, zinc silicate, zinc stearate, zinc sulfide, zinc sulfate, zinc tannate, zinc tartrate, zinc valerate, or any combination thereof.

12. The biocide composition of claim 1, wherein the zinc compound comprises a binary zinc compound selected from the group consisting of zinc oxide, zinc sulfide, zinc fluoride, zinc iodide, zinc chloride, zinc bromide, zinc peroxide, zinc hydride, zinc carbide, zinc nitride, or any combination thereof.

13. The biocide composition of claim 1, wherein the organic amine comprises a compound of the following formula
NR¹R²R³
wherein
R¹, R², and R³ are individually hydrogen or a C₁₋₅ alkyl, optionally substituted, wherein at least one of R¹, R², and R³ is a C₁₋₅ alkyl, optionally substituted.

14. The biocide composition of claim 13, wherein at least two of R¹, R², and R³ are hydrogen and at least one of R¹, R², and R³ is a C₁₋₅ alkyl.

15. The biocide composition of claim 13, wherein the C₁₋₅ alkyl is substituted with a hydroxyl group.

16. The biocide composition of claim 1, wherein the organic amine comprises an alkanolamine.

17. The biocide composition of claim 16, wherein the organic amine comprises ethanolamine.

18. The biocide composition of claim 1, wherein the composition further comprises a second organic amine.

19. The biocide composition of claim 18, wherein the second organic amine is selected from the group consisting of a monomer or a polymer of an alkyl diamine of the following formula
R⁷R⁸N—[(CH₂)ₚ—CH₂—NH—]_{q}—H
wherein
R⁷ and R⁸ are individually hydrogen or a C₁₋₅ alkyl, optionally substituted,
p is 1 or 2, and
q is from about 1 to about 2000.

20. The biocide composition of claim 1, wherein the composition comprises 1,2-benzisothiazolin-3-one, sodium pyrithione, zinc chloride, and ethanolamine.

21. The biocide composition of claim 1, wherein the weight ratio of the pyrithione to the isothiazolinone is from 0.1 to 10.

22. The biocide composition of claim 1, wherein the weight ratio of the isothiazolinone to the zinc compound is from 0.005 to 200.

23. An end-use formulation comprising the biocide composition of claim 1,

24. The end-use formulation of claim 23, wherein the end-use formulation comprising a coating composition.

25. A method of preserving a substrate, the method comprising applying the coating composition of claim 24 to the substrate.

26. A biocide composition concentrate comprising:
an isothiazolinone,
a pyrithione,
a zinc compound, and
an organic amine.

27. The biocide composition concentrate of claim 26, wherein the isothiazolinone comprises 1,2-benzisothiazolin-3-one, the pyrithione comprises sodium pyrithione, the zinc compound comprises zinc chloride, and the organic amine comprises ethanolamine.

28. The biocide composition concentrate of claim 26, wherein the weight ratio of the pyrithione to the isothiazolinone is from 0.1 to 10.

29. The biocide composition concentrate of claim 26, wherein the weight ratio of the isothiazolinone to the zinc compound is from 0.005 to 200.
